(19) United States
(12) Patent Application Publication
(10) Pub. No.: US 2007/0255490 A1
(43) Pub. Date: Nov. 1, 2007

(54) Plug-in satellite navigation device

(76) Inventor: Chii-Moon Liou, Taipei Hsien (TW)

Correspondence Address: CHII-MOON LIOU, 235 Chung - Ho Box 8-24, Taipei, TW

(21) Appl. No.: 11/410,867

(22) Filed: Apr. 26, 2006

(51) Int. Cl. G01C 21/00

(52) U.S. Cl. 701/200

(57) ABSTRACT

A plug-in satellite navigation device comprises a handle hold device having a slot which is electrically connected to a central processing unit; an intellectual satellite navigation receiver having an interface at a front end thereof; The interface can be inserted into the slot of the handle hold device; a memory in the intellectual satellite navigation receiver for storing software, main programs, electrical maps, drawing data; a display unit in a surface of the handle hold device; the display unit being electrically connected to the central processing unit; the display unit having a navigation icon, a map icon, a film icon, a mobile phone icon, a network icon; a power manage unit electrically connected to the central processing unit for supplying power to the central processing unit and intellectual satellite navigation receiver; and an auto program detection-and-actuation device connected to the intellectual satellite navigation receiver.

### FIELD OF THE INVENTION

The present invention relates to navigation device, and particularly to a plug-in satellite navigation device, wherein a handle hold device has a slot for receiving a front interface of an intellectual satellite navigation receiver. The intellectual satellite navigation receiver is connected to an auto program detection-and-actuation device. When the intellectual satellite navigation receiver is inserted into the slot of the handle hold device; the auto program detection-and-actuation device will automatically actuate a window icon on the display unit; if the user click the navigation icon, the auto program detection-and-actuation device will actuate an electric map in the memory, and the main program will actuate the intellectual satellite navigation receiver for navigation.

### BACKGROUND OF THE INVENTION

The prior art satellite navigation receiver (for example, GPS Global positioning system) is an external PDA or a tablePC. It is used with a memory with electric map main programs and drawing data so as to have the function of satellite navigation. However the use of this receiver need a series complicated actuation program and thus those unfamiliar with computers can not operate this kind of device. Thus, it is a troublesome to users. Thus it becomes that this device is seldom used, even it is not used.

### SUMMARY OF THE INVENTION

The object of the present invention is to provide a plug-in satellite navigation device, wherein an intellectual satellite navigation receiver can be inserted into a handle hold device easily and conveniently and the intellectual satellite navigation receiver can be used immediately as it is actuated

To achieve above object, the present invention provides a plug-in satellite navigation device which comprises a handle hold device having a slot which is electrically connected to a central processing unit; an intellectual satellite navigation receiver having an interface at a front end thereof; The interface can be inserted into the slot of the handle hold device; a memory in the intellectual satellite navigation receiver for storing software, main programs, electrical maps, drawing data; a display unit in a surface of the handle hold device; the display unit being electrically connected to the central processing unit; the display unit having a navigation icon, a map icon, a film icon, a mobile phone icon, a network icon; a power manage unit electrically connected to the central processing unit for supplying power to the central processing unit and intellectual satellite navigation receiver; an auto program detection-and-actuation device connected to the intellectual satellite navigation receiver. When the intellectual satellite navigation receiver is inserted into the slot of the handle hold device; the auto program detection-and-actuation device will automatically actuate a window icon on the display unit; if the user click the navigation icon, the auto program detection-and-actuation device will actuate an electric map in the memory, and the main program will actuate the intellectual satellite navigation receiver for navigation.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 shows the icons in the display unit of the present invention.

FIG. 4 shows a block diagram of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

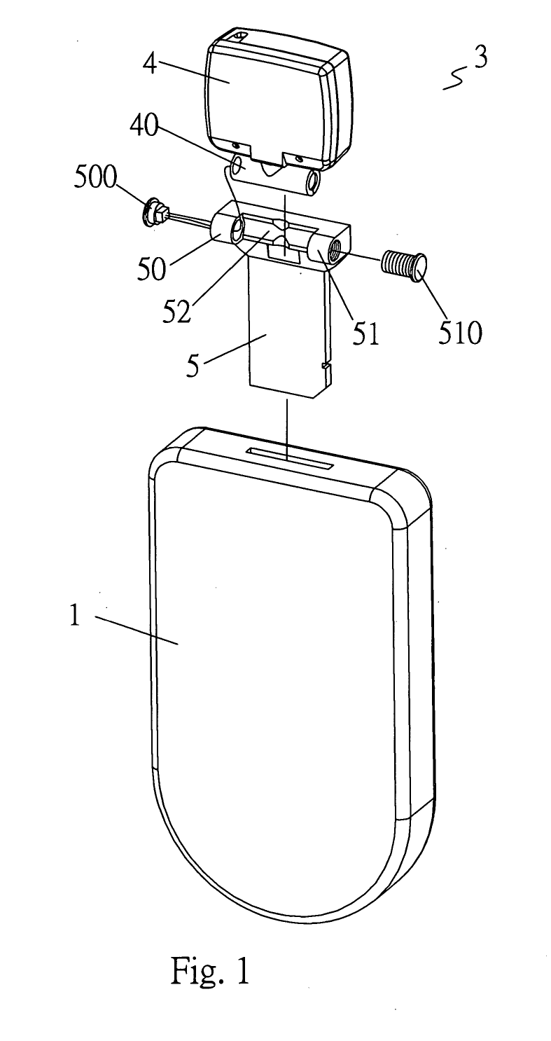

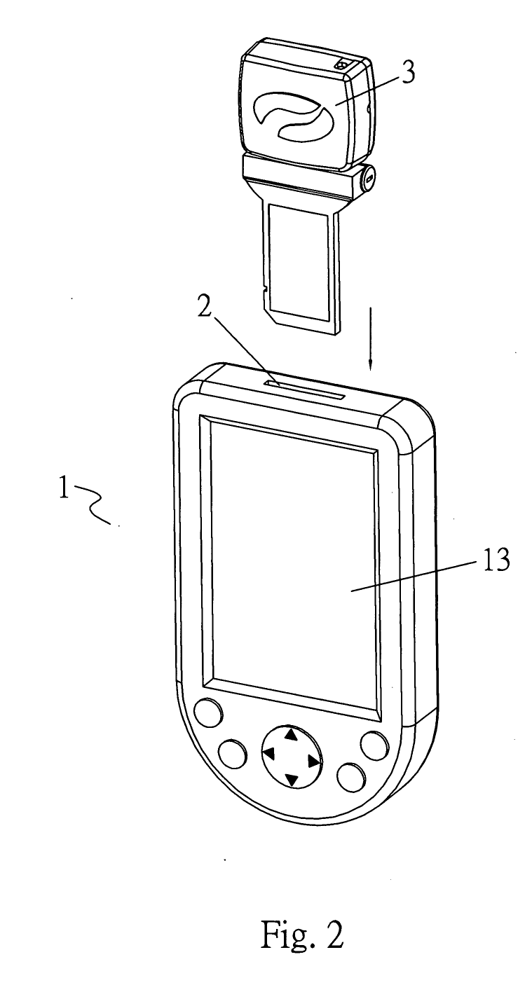

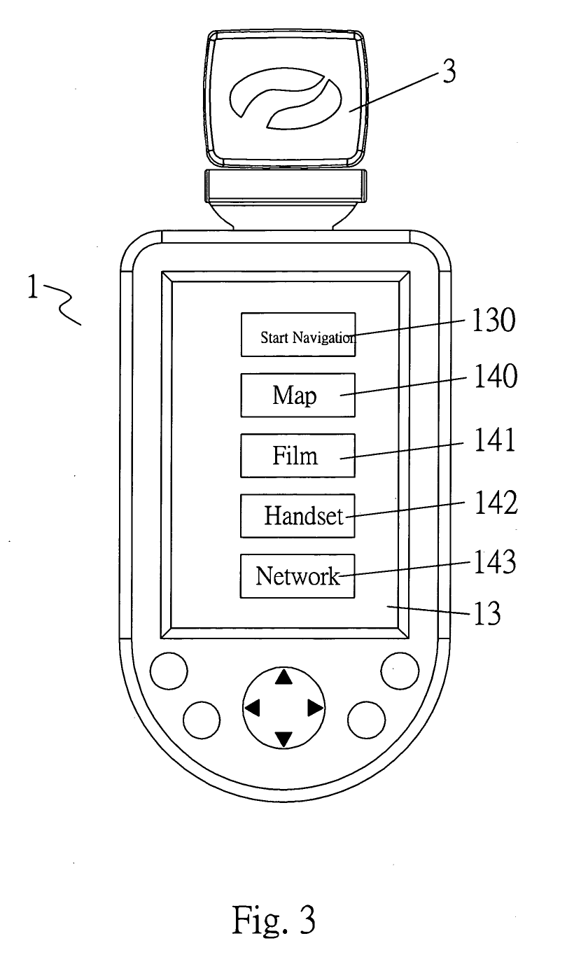

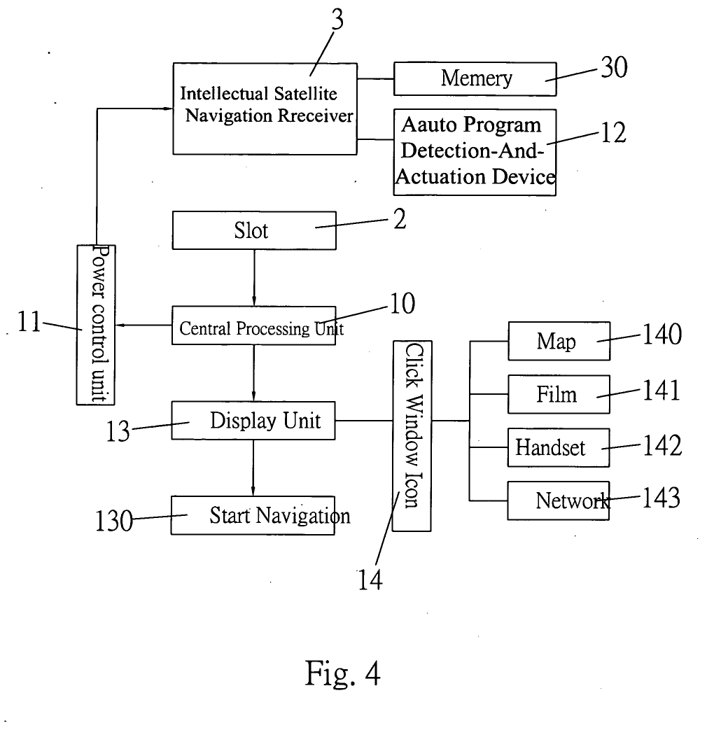

Referring to FIGS. 1 to 4, the present invention is illustrated. The present invention has the following elements.

A handle hold device 1 has a slot 2 which is electrically connected to a central processing unit 10.

An intellectual satellite navigation receiver 3 has an interface at a front end thereof. The interface is for example, an SD interface, or a CF interface, etc. The interface can be inserted into the slot 2 of the handle hold device 1.

A memory 30 in the intellectual satellite navigation receiver 3 serves for storing software, main programs, electrical maps, drawing data, etc.

A display unit 13 is on a surface of the handle hold device 1. The display unit 13 is electrically connected to the central processing unit 10. The display unit 13 is a liquid crystal display.

A power manage unit 11 is electrically connected to the central processing unit 10 for supplying power to the central processing unit 10 and the intellectual satellite navigation receiver 3.

An auto program detection-and-actuation device 12 is connected to the intellectual satellite navigation receiver 3. When the intellectual satellite navigation receiver 3 is inserted into the slot 2 of the handle hold device 1. The auto program detection-and-actuation device 12 will automatically actuate a window icon 14 on the display unit 13. Thereby the user can click a navigation icon 130, or a map icon 140, a film icon 141, a mobile phone icon 142, a network icon 143, etc. If the user clicks the navigation icon 130, the auto program detection-and-actuation device 12 will actuate an electric map in the memory 30, and the main program will actuate the intellectual satellite navigation receiver 3 for navigation.

Advantages of the present invention are that the intellectual satellite navigation receiver can be used immediately as it is inserted into the handle hold device without needing complicated operation processes. An intellectual satellite navigation receiver can be used with various handle hold devices (PDAs). Thereby any person can use the present invention even those can not use a computer.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A plug-in satellite navigation device comprising:
a handle hold device having a slot which is electrically connected to a central processing unit;
an intellectual satellite navigation receiver having an interface at a front end thereof; the interface can be inserted into the slot of the handle hold device;
a memory in the intellectual satellite navigation receiver for storing software, main programs, electrical maps, and drawing data;
a display unit in a surface of the handle hold device; the display unit being electrically connected to the central processing unit; the display unit having a navigation icon, a map icon, a film icon, a mobile phone icon, and a network icon;
a power manage unit electrically connected to the central processing unit for supplying power to the central processing unit and intellectual satellite navigation receiver; and
an auto program detection-and-actuation device connected to the intellectual satellite navigation receiver; and
wherein when the intellectual satellite navigation receiver is inserted into the slot of the handle hold device; the auto program detection-and-actuation device will automatically actuate a window icon on the display unit; if the user click the navigation icon, the auto program detection-and-actuation device will actuate an electric map in the memory, and the main program will actuate the intellectual satellite navigation receiver for navigation.

2. The plug-in satellite navigation device as claimed in claim 1, wherein the interface is for example, an SD interface, or a CF interface.

3. The plug-in satellite navigation device as claimed in claim 1, wherein the display unit is a liquid crystal display.
